(19) United States
(12) Patent Application Publication
(10) Pub. No.: US 2018/0191165 A1
(43) Pub. Date: Jul. 5, 2018

(54) MULTIPOLAR PHOTOVOLATIC PANEL

(71) Applicant: SunPower Corporation, San Jose, CA (US)

(72) Inventor: Jonathan Ehlmann, Austin, TX (US)

(21) Appl. No.: 15/396,622

(22) Filed: Dec. 31, 2016

(51) Int. Cl. H02J 3/38; H02S 40/32; H02M 7/539; H02M 3/335

(52) U.S. Cl. CPC H02J 3/383; H02M 3/33546; H02M 7/539; H02S 40/32

(57) ABSTRACT

A multipolar solar module may include a string of series-connected solar cells and three or more terminals that are coupled to a module-level power electronic device (MLPE). A first terminal may be coupled to positive end of the string of series-connected solar cells, a second terminal may be coupled to the midpoint of the string of series-connected, and a third terminal may be coupled to the negative end of the string of series-connected solar cells. The voltage between the first terminal and the second terminal may be +Vpanel/2, and the voltage between the third terminal and the second terminal may be −Vpanel/2. Various topologies may be used inside the MLPE without some components that would be required in a unipolar solar module.

### BACKGROUND

Solar power has long been viewed as an important alternative energy source. To this end, substantial efforts and investments have been made to develop and improve upon solar energy collection technology. Of particular interest are residential-, industrial- and commercial-type applications in which relatively significant amounts of solar energy can be collected and utilized in supplementing or satisfying power needs. One way of implementing solar energy collection technology is by assembling an array of multiple solar modules.

One type of a solar energy system is a solar module system. Solar modules may utilize various technologies and materials to produce energy from received sunlight. For example, one type of a solar module system is a solar photovoltaic system (“photovoltaic system”), which can employ solar panels made of silicon or other materials (e.g., III-V cells such as GaAs) to convert sunlight into electricity. Photovoltaic systems typically include a plurality of photovoltaic (PV) modules interconnected with wiring to one or more appropriate electrical components (e.g., switches, inverters, junction boxes, etc.). Another type of a solar module system is a photoelectrochemical module system, which can employ solar panels made from dye-sensitive solar cells.

A typical conventional PV module includes a PV laminate or panel having an assembly of crystalline or amorphous semiconductor devices (“PV cells”) electrically interconnected in series in one or more strings and encapsulated within a weather-proof barrier. The PV laminate or panel is the energy generation portion of the panel and generates electrical power when exposed to light. One or more electrical conductors are housed inside the PV laminate through which the solar-generated current is conducted. The PV laminate or panel may be integrated into a module including a junction box to protect portions of the electrical conductors coming out of the laminate or panel. A module-level power electronic device (MLPE) may be coupled to the portions of the electrical conductors coming out of the laminate or panel. In a conventional PV module, the connection between the MLPE and energy generation portion is unipolar in which the MLPE and energy generation portion are coupled together with a pair of electrical conductors and the voltage between the pair of electrical conductors is the total voltage of the panel.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A is a simplified electrical schematic of a multipolar photovoltaic (PV) solar module including a laminate and a module-level power electronic device (MLPE) according to various embodiments;

FIG. 1B is a simplified electrical schematic of an alternative multipolar PV solar module including an energy generation portion and an MLPE according to various embodiments;

FIG. 2 is a simplified electrical schematic of a topology that may be used inside the MLPE of FIGS. 1A and 1B according to various embodiments;

FIG. 3A is a simplified electrical schematic showing a neutral clamp inverter topology that may be used inside the MLPE of FIGS. 1A and 1B according to various embodiments;

FIG. 3B is a simplified electrical schematic showing a portion of the neutral clamp inverter topology of FIG. 3A coupled to the energy generation portion of FIG. 1A according to various embodiments;

FIG. 3C is a simplified electrical schematic showing a portion of another embodiment of a neutral claim inverter topology that may be used inside the MLPE of FIGS. 1A and 1B according to various embodiments;

FIG. 4 is a simplified electrical schematic showing a four-legged inverter topology coupled to the energy generation portion of FIG. 1A according to various embodiments;

FIG. 5 is a simplified electrical schematic showing a topology with a galvanically-isolated input portion and output portion coupled to the energy generation portion of FIG. 1A according to various embodiments;

FIG. 6 is a simplified electrical schematic showing a topology with a galvanically-isolated input portion and output portion and a filter portion electrically coupled to the output portion coupled to the energy generation portion of FIG. 1A according to various embodiments;

FIG. 7 is a simplified electrical schematic showing a topology with an output portion with a half-bridge and an unfolding bridge coupled to the energy generation portion of FIG. 1A according to various embodiments;

FIG. 8 is a simplified electrical schematic showing a topology with a galvanically-isolated input portion, output portion, and filter portion coupled to the energy generation portion of FIG. 1A according to various embodiments; and

FIG. 9 is a simplified electrical schematic showing an alternative topology with a galvanically-isolated input portion, output portion, and filter portion coupled to the energy generation portion of FIG. 1A according to various embodiments.

### SUMMARY

Embodiments may include a solar module comprising a string of series-connected solar cells having a total voltage Vpanel; a first terminal disposed at a positive end of the string; a second terminal disposed at a midpoint of the string wherein half of the solar cells in the string occur before the midpoint in series; and a third terminal disposed at a negative end of the string. The voltage between the first terminal and the third terminal can be +Vpanel/2 volts, and the voltage between the second terminal and the third terminal can be +Vpanel/2 volts.

Embodiments may also include a solar module comprising an energy generation portion comprising a string of series-connected solar cells having a total voltage Vpanel; a first terminal disposed at a positive end of the string; a second terminal disposed at a midpoint of the string wherein half of the solar cells in the string occur before the midpoint in series; and a third terminal disposed at a negative end of the string. The voltage between the first terminal and the third terminal can be +Vpanel/2 volts and the voltage between the second terminal and the third terminal can be +Vpanel/2 volts. A module level power electronic (MLPE) device can be coupled to the energy generation portion. The MLPE device can comprise a positive output terminal; a negative output terminal coupled to the second terminal of the energy generation portion; a capacitor having a positive terminal and a negative terminal; a first electrical switch having a first terminal and a second terminal; and a second electrical switch having a first terminal and a second terminal. The positive terminal of the capacitor, the first terminal of the energy generation portion, and the first terminal of the first electrical switch can be coupled together. The negative terminal of the capacitor, the third terminal of the energy generation portion, and the second terminal of the second electrical switch can be coupled together. The second terminal of the first electrical switch, the first terminal of the second electrical switch, and the positive output terminal can be coupled together.

Embodiments may further include a solar module comprising an energy generation portion comprising a string of series-connected solar cells having a total voltage Vpanel; a first terminal disposed at a positive end of the string; a second terminal disposed at a midpoint of the string wherein half of the solar cells in the string occur before the midpoint in series; and a third terminal disposed at a negative end of the string. The voltage between the first terminal and the second terminal can be +Vpanel/2 volts and the voltage between the second terminal and the third terminal can be +Vpanel/2 volts. A neutral point clamped (NPC) inverter can be coupled to the energy generation portion. The neutral point clamped inverter can comprise a positive input terminal coupled to the first terminal of the energy generation portion; a neutral point terminal coupled to the second terminal of the energy generation portion and a negative input terminal coupled to the third terminal of the energy generation portion.

### DETAILED DESCRIPTION

The following detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.”—This term is open-ended. As used in the appended claims, this term does not foreclose additional structure or steps.

“Configured To.”—Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. § 112, sixth paragraph, for that unit/component.

“First,” “Second,” etc.—As used herein, these terms are used as labels for nouns that they precede, and do not imply any type of ordering (e.g., spatial, temporal, logical, etc.). For example, reference to a “first” solar module does not necessarily imply that this solar module is the first solar module in a sequence; instead the term “first” is used to differentiate this solar module from another solar module (e.g., a “second” solar module).

“Based On.”—As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Coupled.”—The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

“Inhibit.”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

In the following description, numerous specific details are set forth, such as specific operations, in order to provide a thorough understanding of embodiments of the present disclosure. It will be apparent to one skilled in the art that embodiments of the present disclosure may be practiced without these specific details. In other instances, well-known techniques are not described in detail in order to not unnecessarily obscure embodiments of the present disclosure.

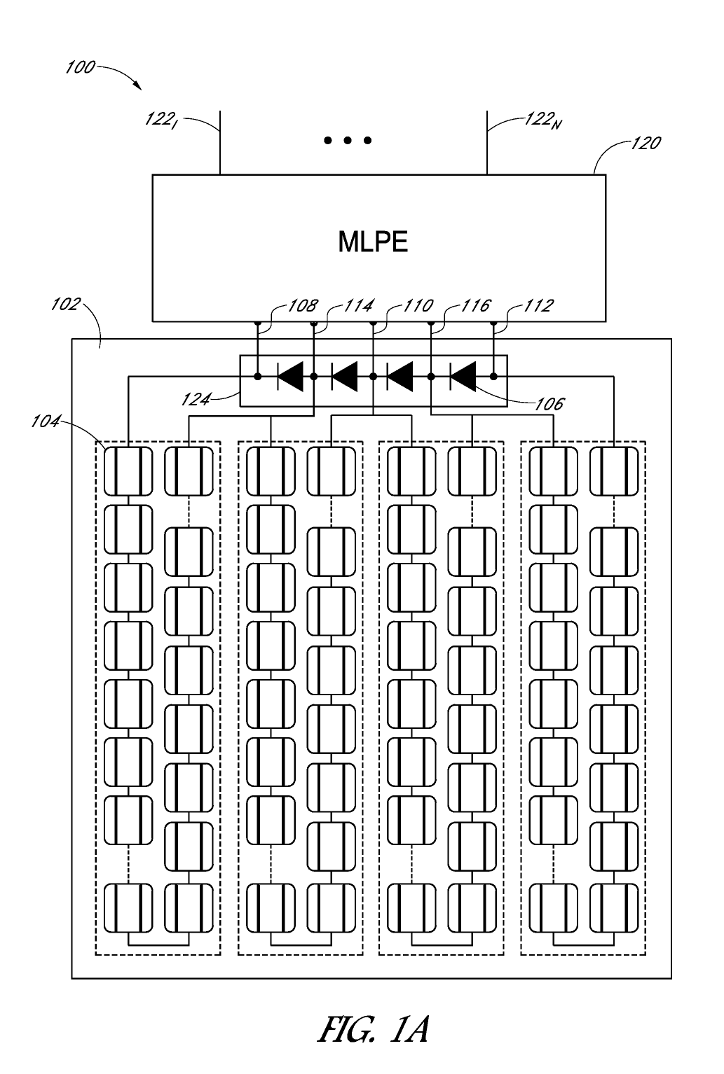

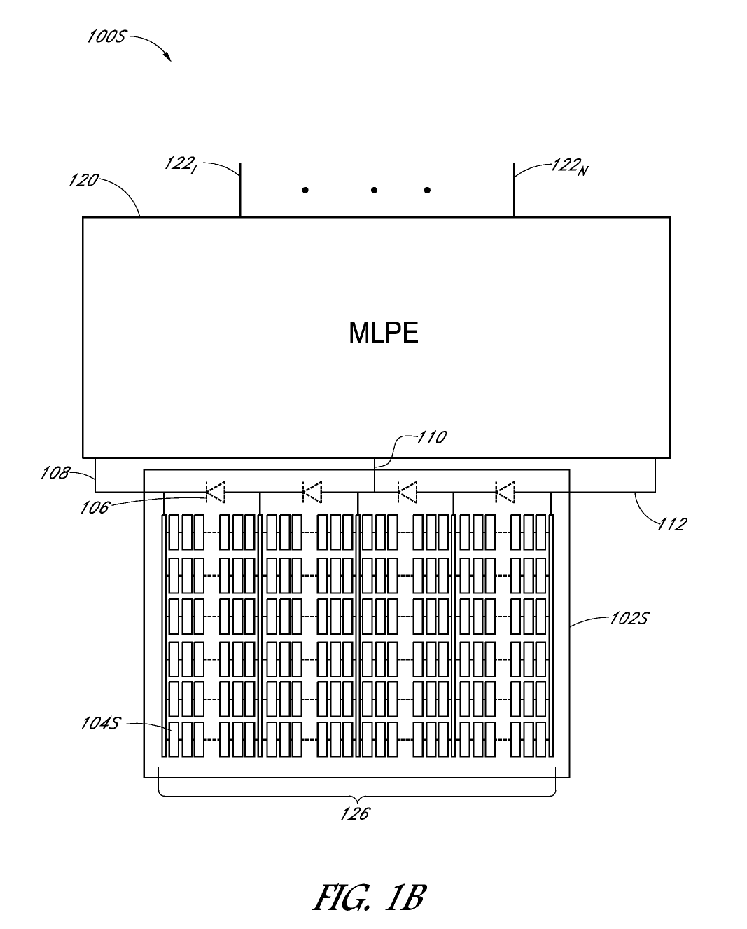

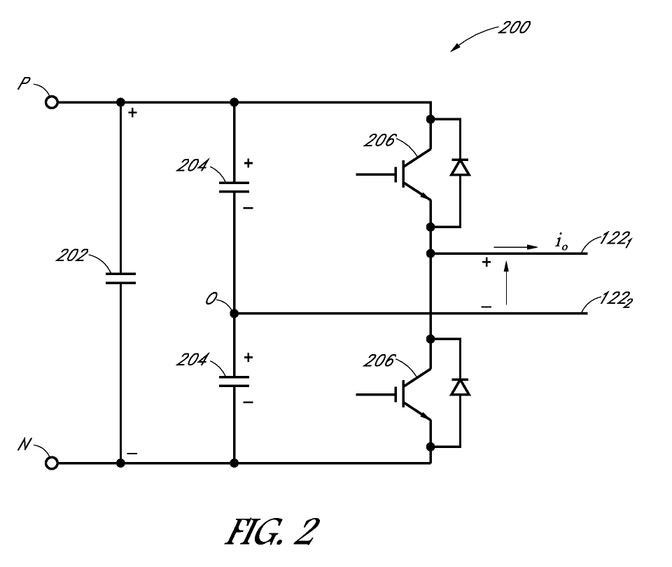

FIG. 1A is a simplified electrical schematic of a multipolar photovoltaic (PV) solar module 100. The solar module 100 (also referred to herein as the module or multipolar module) includes an energy generation portion 102. The energy generation portion 102 includes a plurality of series-connected solar cells 104 organized in a string, as well as layers to protect the solar cells 104 such as glass, encapsulant, and a backsheet (not shown). Alternatively the energy generation portion 102 may be a glass-glass bifacial laminate. A plurality of terminals 108, 110, 112, 114, 116 may be coupled to the string of series-connected solar cell 104 at various points along the string. One or more bypass diodes 106 may be coupled to the plurality of terminals 108, 110, 112, 114, 116. A module-level power electronic device (MLPE) 120 may be coupled to the plurality of terminals 108, 110, 112, 114, 116. Various non-limiting examples of MLPEs 120 are shown in FIGS. 2-9 herein.

The solar cells 104 (also referred to herein as PV cells) may be made of silicon or other materials (e.g., III-V cells such as GaAs) and are configured convert sunlight into electricity. The solar cells 104 may be front-contact solar cells or interdigitated back-contact solar cells. The solar cells 104 are connected in series into a string. Being arranged in series, the total voltage Vpanel of the string of solar cells 104 is the combined voltage of all of the solar cells 104 in the string.

One or more terminals 108, 110, 112, 114, 116 may be coupled to the string of solar cells 104 at various points along the string. While five terminals 108, 110, 112, 114, 116 are shown in FIG. 1A, it will be understood that the module 100 may include three terminals, four terminals, or more. A first terminal 108 is disposed at the positive end of the string of solar cells 104. A third terminal 112 is disposed at the negative end of the string of solar cells 104. A second terminal 110 (also referred to herein as the neutral terminal) may be disposed at the midpoint of the string of solar cells 104 (i.e., half of the string of the solar cells 104 are disposed between the positive end and the midpoint, and the other half the string of the solar cells 104 are disposed between the midpoint and the negative end). The voltage between the first terminal 108 and the second terminal 110 is a positive voltage equal to half of the total voltage of the string of solar cells 104 (+Vpanel/2). The voltage between the third terminal 112 and the second terminal 110 is a negative voltage equal to half of the total voltage of the string of solar cells 104 (−Vpanel/2).

The module 100 may include additional terminals such as a terminal 114 disposed between the positive end and the midpoint of the string of solar cells 104 (e.g., closer to the positive end, halfway between the positive end and the midpoint, or closer to the midpoint) and/or a terminal 116 disposed between the midpoint and the negative end of the string of solar cells 104 (e.g., closer to the midpoint, halfway between the midpoint and the negative end, or closer to the negative end). The voltage between the terminal 114 and the second terminal 110 will depend on where in the string of solar cells the terminal 114 is disposed (e.g., the voltage will be +Vpanel/4 if the terminal 114 is halfway between the positive end and the midpoint). Similarly, the voltage between the terminal 116 and the second terminal 110 will depend on where in the string of solar cells the terminal 116 is disposed (e.g., the voltage will be −Vpanel/4 if the terminal 116 is hallway between the midpoint and the negative end). The terminals 108, 110, 112, 114, 116 may be leads coming out of the energy generation portion 102 (e.g., passing through the backsheet of the energy generation portion 102, passing through a rear glass plate of the energy generation portion 102).

There may be one or more bypass diodes 106 disposed between and coupled to the various terminals of the solar module 100. FIG. 1A shows five bypass diodes 106, each between a terminal and the adjacent terminal (e.g., a bypass diode 106 coupled to the first terminal 108 and terminal 114, a bypass diode 106 coupled to the terminal 114 and the second terminal 110, etc.). It will be understood that the bypass diodes 106 may enable various portions of the string of solar cells 104 to be bypassed when a portion of the string of solar cells 104 becomes reversed biased due to shading, damage, or malfunction. However, as discussed herein, the bypass diodes 106 may be omitted if the topology of the MLPE 120 provides a path for current to bypass a reverse biased portion of the string of solar cells 104. In some embodiments, the terminals 108, 110, 112, 114, 116 and bypass diodes 106 may be encased in a junction box 124.

The MLPE 120 may be coupled to the terminals 108, 110, 112, 114, 116. If there are more or fewer terminals (e.g., the three terminals 108, 110, and 112), the MLPE 120 may be couple to some or all of the terminals of the solar module 100. The MLPE 120 may be embodied as any one of a number of power electronic devices adapted to convert and/or filter the electric power generated by the energy generation portion 102 (e.g., convert lower voltage into higher voltage, convert higher voltage into lower voltage, convert DC power into AC power, convert AC power to DC power, eliminate noise, or a combination) as well as perform functions such as measurement of power generated, communication (e.g., with other solar modules 100, a central controller for a system of solar modules 100, the internet, etc.), safety features (e.g., opening a connection to an electrical grid in response to detecting a grid outage or command to disconnect), etc. As discussed herein, by receiving voltage from the energy generation portion 102 at +Vpanel/2 (from the terminal 108), 0 V (from terminal 110), and −Vpanel/2 (from terminal 112), a number of topologies for the MLPE 120 may be used that otherwise could not be used with a conventional unipolar solar module and other topologies for the MLPE 120 may be implemented with less robust (and less expensive) components and/or may be implemented without needing components that would be necessary in a conventional unipolar solar module. In particular, a multipolar solar module 100 allows for topologies where instead of having a common-mode signal that must be filtered out, the common-mode signal can be sent to the 0 V terminal (i.e., the terminal 110) without filtering. Accordingly, large, discrete filtering capacitors can be omitted from the MLPE topology in some embodiments. Additionally, the bypass diodes 106 may be omitted as discussed herein. The MLPE 120 may be coupled to a system including other solar modules 100 and to an electrical grid using two or more output terminals 122 (e.g., an output terminal 122₁, an output terminal 122₂, an output terminal 122ₙ, etc.).

FIG. 1B is a simplified electrical schematic of an alternate multipolar photovoltaic (PV) solar module 100S. The solar module 100S of FIG. 1B may include the same components as the solar module 100 of FIG. 1A, but the energy generation portion 102S of the solar module 100S comprises multiple strings of solar cells 104S arranged in shingled super cells 126. In each super cell 126 of solar cells 104S, adjacent solar cells 104S are conductively bonded to each other in the region in which they overlap by an electrically conducting bonding material that electrically connects the front surface metallization pattern of one solar cell to the rear surface metallization pattern of the adjacent solar cell. Suitable electrically conducting bonding materials may include, for example, electrically conducting adhesives and electrically conducting adhesive films and adhesive tapes, and conventional solders. Preferably, the electrically conducting bonding material provides mechanical compliance in the bond between the adjacent solar cells that accommodates stress arising from mismatch between the coefficient of thermal expansion (CTE) of the electrically conducting bonding material and that of the solar cells (e.g., the CTE of silicon). To provide such mechanical compliance, in some variations the electrically conducting bonding material is selected to have a glass transition temperature of less than or equal to about 0° C. To further reduce and accommodate stress parallel to the overlapping edges of the solar cells arising from CTE mismatch, the electrically conductive bonding material may optionally be applied only at discrete locations along the overlapping regions of the solar cells rather than in a continuous line extending substantially the length of the edges of the solar cells. Each super cell 126 (six are shown in FIG. 1B) is connected in electrical parallel with the other super cells 126 of the energy generation portion 102S. Accordingly, the total voltage across the energy generation portion 102S, Vpanel, is the voltage across each super cell 126.

The energy generation portion 102S may be coupled to the MLPE 120 by the three terminals 108, 110, and 112 (disposed at the positive end, midpoint, and negative end of the energy generation portion 102S). As with the solar module 100 of FIG. 1A, the voltage between terminal 108 and terminal 110 is +Vpanel/2 and the voltage between terminal 112 and terminal 110 is −Vpanel/2. It will be understood that as with the solar module 100, the energy generation portion 102S may be coupled to the MLPE 120 by more terminals (e.g., terminals 114, 116) with difference voltages relative to terminal 110 depending on where in the laminate the terminal is disposed.

FIG. 2 is a simplified electrical schematic showing a topology 200 that may be used inside the MLPE 120 of FIGS. 1A and 1B. The topology 200 is a bipolar half-bridge topology. The energy generation portion 102 may be coupled to an MLPE 120 with topology 200 by the terminals 108, 110, and 112 at nodes P, O, and N, respectively. The topology 200 includes a capacitor 202 and controlled switches 206. In some embodiments, the capacitor 202 may be embodied as a parasitic or inherent capacitance of the energy generation portion 102/102S. The controlled switches 206 are shown as power MOSFETs, but it will be understood that any electrically-controlled switch (e.g., power BJT, thyristor, etc.) may be used. Depending on the control technique used to open and close the controlled switches 206, an MLPE 120 with topology 200 may be configured to be a DC converter (e.g., a boost converter) or as a DC-AC inverter. The topology 200 also includes two capacitors 204, however, unlike a typical implementation of a half-bridge topology, the topology 200 may rely on the inherent capacitance between terminals 108 and 110 and between terminals 110 and 112 to filter high frequency signals. Accordingly, an MLPE 120 with topology 200 may not have a separate capacitor coupled to terminals 108 and 110 and another separate capacitor coupled to terminals 110 and 112, thus saving component costs.

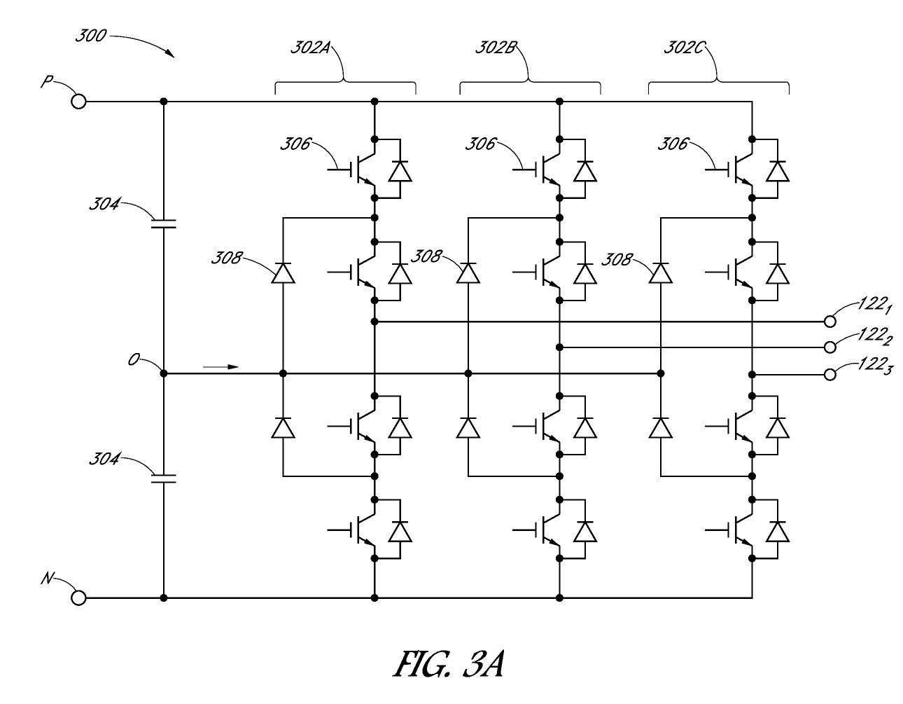

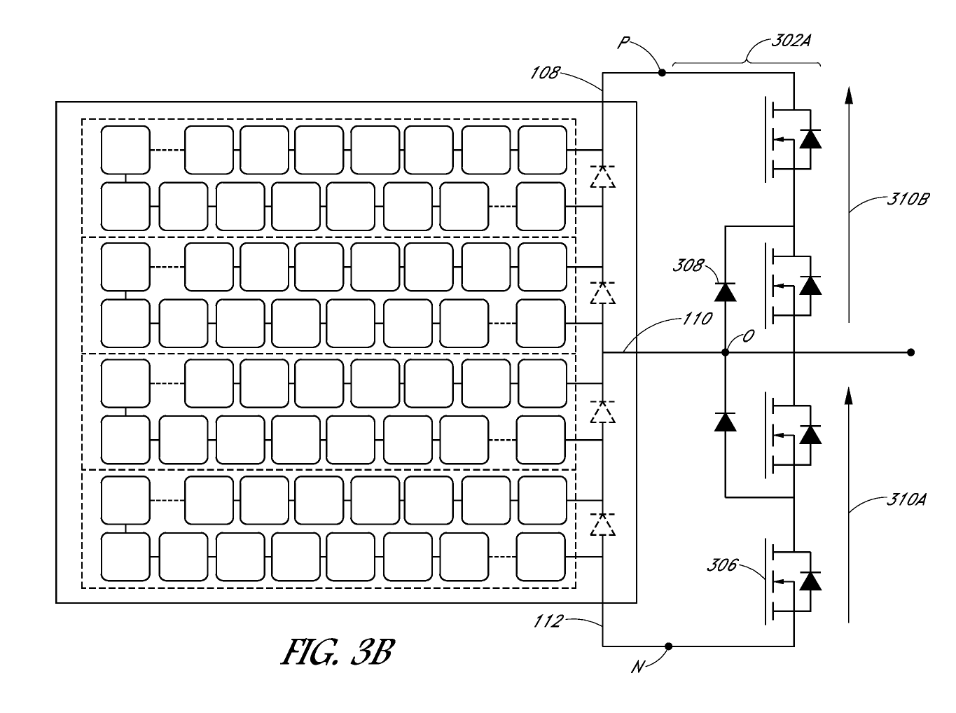

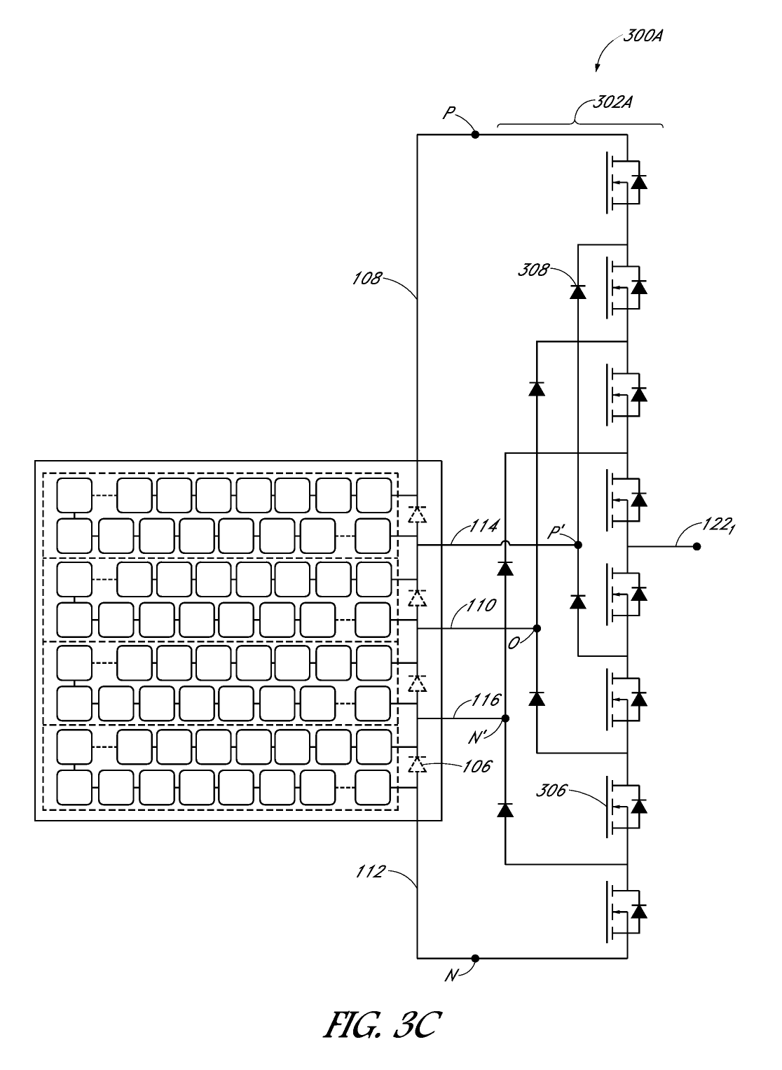

FIG. 3A is a simplified electrical schematic showing another topology 300 that may be used inside the MLPE 120 of FIGS. 1A and 1B. The topology 300 is a three-phase neutral point clamped (NPC) inverter topology. The energy generation portion 102 may be coupled to an MLPE 120 with topology 300 by the terminals 108, 110, and 112 at nodes P, O, and N, respectively. The topology 300 includes three phases 302A, 302B, 302C. Each phase 302 includes two pairs of controlled switches 306 (one pair coupled to points P and O and the other pair coupled to points O and N) and two clamping diodes 308 coupled to node O and a node between one of the pairs of controlled switches 306. The controlled switches 306 are shown as power MOSFETs, but it will be understood that any electrically-controlled switch (e.g., power BJT, thyristor, etc.) may be used. The control technique used to control the topology 300 will cause the bipolar DC power inputted to the topology 300 at nodes P, O, and N, to be outputted as three-phase AC power at the terminals 122₁, 122₂, and 122₃. The topology 300 also includes two capacitors 304, however, unlike a typical implementation of a half-bridge topology, the topology 200 may rely on the inherent capacitance between terminals 108 and 110 and between terminals 110 and 112 to filter high frequency signals (e.g., noise). Accordingly, an MLPE 120 with topology 300 may not have a separate capacitor coupled to terminals 108 and 110 and another separate capacitor coupled to terminals 110 and 112, thus saving component costs.

FIG. 3B is a simplified electrical schematic showing the first phase 302A of the topology 300 coupled to an energy generation portion 102 at nodes P, O, and N. It will be understood that instead of an energy generation portion 102, the topology 300 may be coupled to the energy generation portion 102S as discussed herein. The bypass diodes 106 may be omitted from the module 100 because an alternate bypass paths 310A and 310B may be established through the controlled switches 306 and clamping diodes 308. Further, no separate capacitors 304 are shown because the inherent capacitance between the terminals 108 and 110 and between terminals 110 and 112 filters high frequency noise as discussed herein.

FIG. 3C is a simplified electrical schematic showing the first phase 302A of another topology 300A that may be used inside the MLPE 120 of FIGS. 1A and 1B. The topology 300A is a five-level neutral point clamp (NPC) inverter topology. The energy generation portion 102 may be coupled to an MLPE 120 with topology 300A by the terminals 108, 110, 112, 114, and 116 at nodes P, O, N, P′, and N′, respectively. The first phase 302A includes four pairs of controlled switches 306. A first pair of controlled switches 306 is coupled between nodes P and O, a second pair of controlled switches is coupled between node O and the first output terminal 122₁ of the first phase 302A, a third pair of controlled switches 306 is coupled between the first output terminal 122₁ and the node O, and a fourth pair of switches is coupled between the node N and the node O. As discussed above, the voltage between terminals 114 and 110 is +Vpanel/4 if the terminal 114 is halfway between the positive end and the midpoint, and the voltage between terminals 110 and 116 is Vpanel/4 if the terminal 116 is halfway between the midpoint and the negative end.

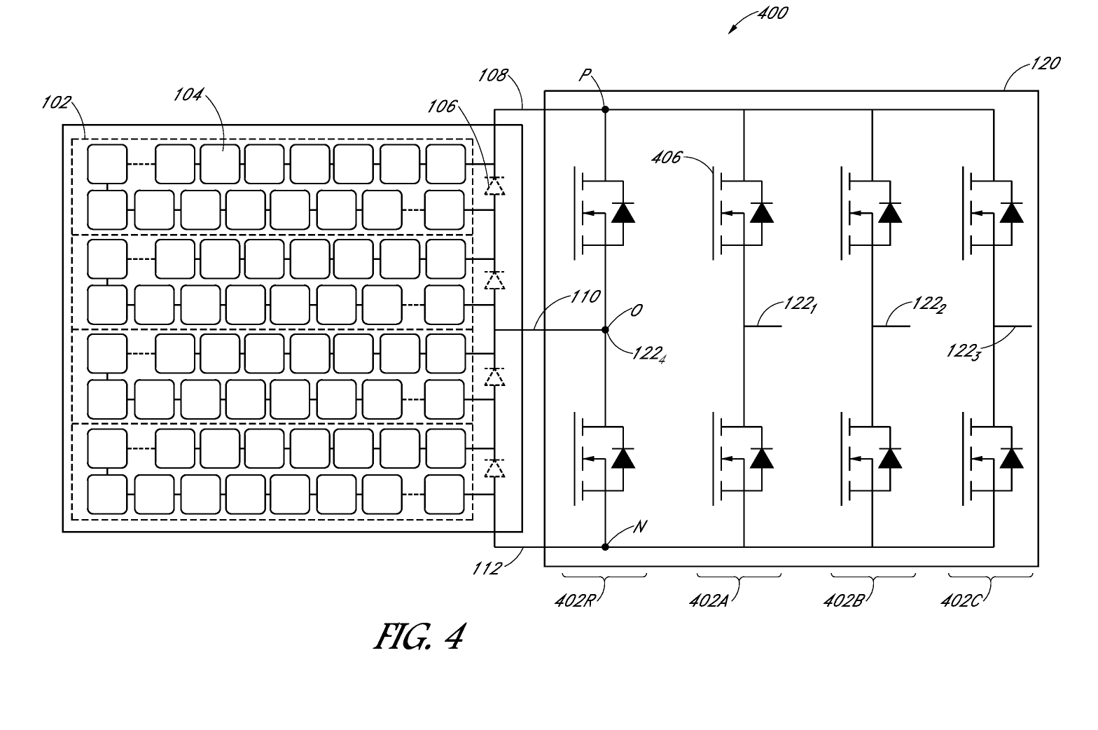

FIG. 4 is a simplified electrical schematic showing another topology 400 that may be used inside the MLPE 120 of FIGS. 1A and 1B. An energy generation portion 102 is shown in FIG. 4, although it will be understood that an energy generation portion 102S may be used instead. The energy generation portion 102 may be coupled to an MLPE 120 with topology 400 by the terminals 108, 110, and 112 at nodes P, O, and N, respectively. The topology 400 is a four-legged inverter topology. The topology 400 may include four bridges 402A, 402B, 402C, 402R. Each bridge 402 may include controlled switches 406 arranged in a half bridge arrangement (as shown in FIG. 4) or in a full bridge arrangement (not shown). The controlled switches 406 are shown as power MOSFETs, but it will be understood that any electrically-controlled switch (e.g., power BJT, thyristor, etc.) may be used. The control technique used to control the topology 400 will cause the bipolar DC power inputted to the topology 400 at nodes P, O, and N, to be outputted as three-phase AC power at the terminals 122₁, 122₂, and 122₃ with terminal 122₄ (i.e., node O) as a return current path. Additionally, node O may provide a neutral voltage for the DC-to-AC inverter formed the four bridges 402A, 402B, 402C, 402R in some embodiments. The bypass diodes 106 may be omitted from the module 100 because an alternate bypass paths may be established through the controlled switches 406. Further, no separate capacitors are shown because the inherent capacitance between the terminals 108 and 110 and between terminals 110 and 112 filters high frequency noise as discussed herein.

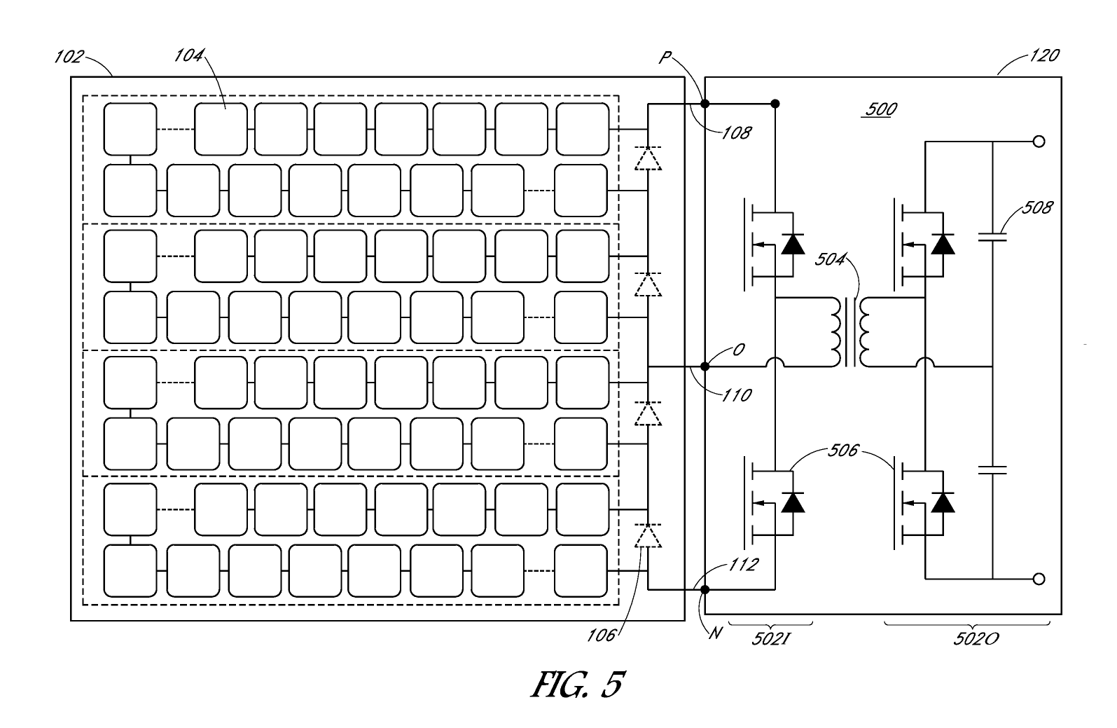

FIG. 5 is a simplified electrical schematic showing another topology 500 that may be used inside the MLPE 120 of FIGS. 1A and 1B. An energy generation portion 102 is shown in FIG. 5, although it will be understood that an energy generation portion 102S may be used instead. The energy generation portion 102 may be coupled to an MLPE 120 with topology 500 by the terminals 108, 110, and 112 at nodes P, O, and N, respectively. The topology 500 includes an input portion 502I and an output portion 502O, each including controlled switches 506. The controlled switches 506 are shown as power MOSFETs, but it will be understood that any electrically-controlled switch (e.g., power BJT, thyristor, etc.) may be used. The input portion 502I and output portion 502O are both coupled to a transformer 504, which also galvanically isolates the input portion 502I from the output portion 502O. The input portion 502I and output potion 502O cooperate to form DC-DC phase shift resonant converter. The input portion 502I is embodied as a DC-AC converter and, depending on the control algorithm used to control the controlled switches 506 of the input portion 502I, the input portion 502I may be operated to either boost or buck voltage. The output portion 502O is embodied as an AC-DC half-bridge converter (although a full bridge arrangement could also be used) with a pair of filtering capacitors 508. Of course, in other embodiments, the output portion 502O may be configured as an AC-AC inverter if the controlled switches 506 are embodied as bi-directional blocking switches and the control algorithm used to control the switches 506 is configured for AC-AC conversion. The bypass diodes 106 may be omitted from the module 100 because an alternate bypass paths may be established through the controlled switches 506 in the input portion 502I. Further, no separate capacitors are shown because the inherent capacitance between the terminals 108 and 110 and between terminals 110 and 112 filters high frequency noise as discussed herein.

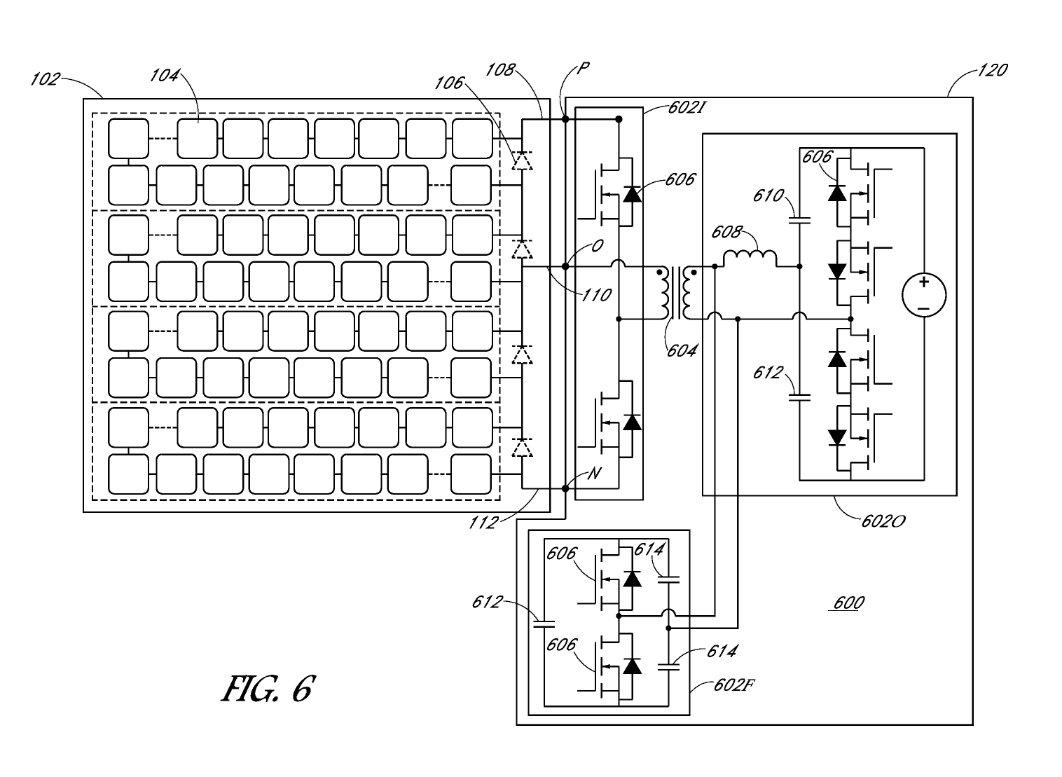

FIG. 6 is a simplified electrical schematic showing another topology 600 that may be used inside the MLPE 120 of FIGS. 1A and 1B. An energy generation portion 102 is shown in FIG. 6, although it will be understood that an energy generation portion 102S may be used instead. The energy generation portion 102 may be coupled to an MLPE 120 with topology 600 by the terminals 108, 110, and 112 at nodes P, O, and N, respectively. The topology 600 includes an input portion 602I, a filter portion 602F, and an output portion 602O, each including controlled switches 606. The controlled switches 606 are shown as power MOSFETs, but it will be understood that any electrically-controlled switch (e.g., power BJT, thyristor, etc.) may be used. The input portion 602I and output portion 602O are both coupled to a transformer 604, which also galvanically isolates the input portion 602I from the output portion 602O. The input portion 602I and output portion 602O cooperate to form a DC-DC phase shift resonant converter. The input portion 602I is embodied as a DC-AC converter and, depending on the control algorithm used to control the controlled switches 606 of the input portion 602I, the input portion 602I may be operated to either boost or buck voltage. The output portion 602O is embodied as an AC-DC half-bridge converter (although a full bridge arrangement could also be used) with a pair of filtering capacitors 608. Of course, in other embodiments, the output portion 602O may be configured as an AC-AC inverter if the controlled switches 606 are embodied as bi-directional blocking switches and the control algorithm used to control the switches 606 is configured for AC-AC conversion. The output portion 602O may include filtering capacitors 610 and an inductor 612. The filter portion 602F may be electrically coupled to the output portion 602O. The filter portion 602F shown in FIG. 6 is an active filter including controlled switches 606, a bus capacitor 612 and filtering capacitors 614. The bypass diodes 106 may be omitted from the module 100 because an alternate bypass paths may be established through the controlled switches 606 in the input portion 602I. Further, no separate capacitors are shown because the inherent capacitance between the terminals 108 and 110 and between terminals 110 and 112 filters high frequency noise as discussed herein.

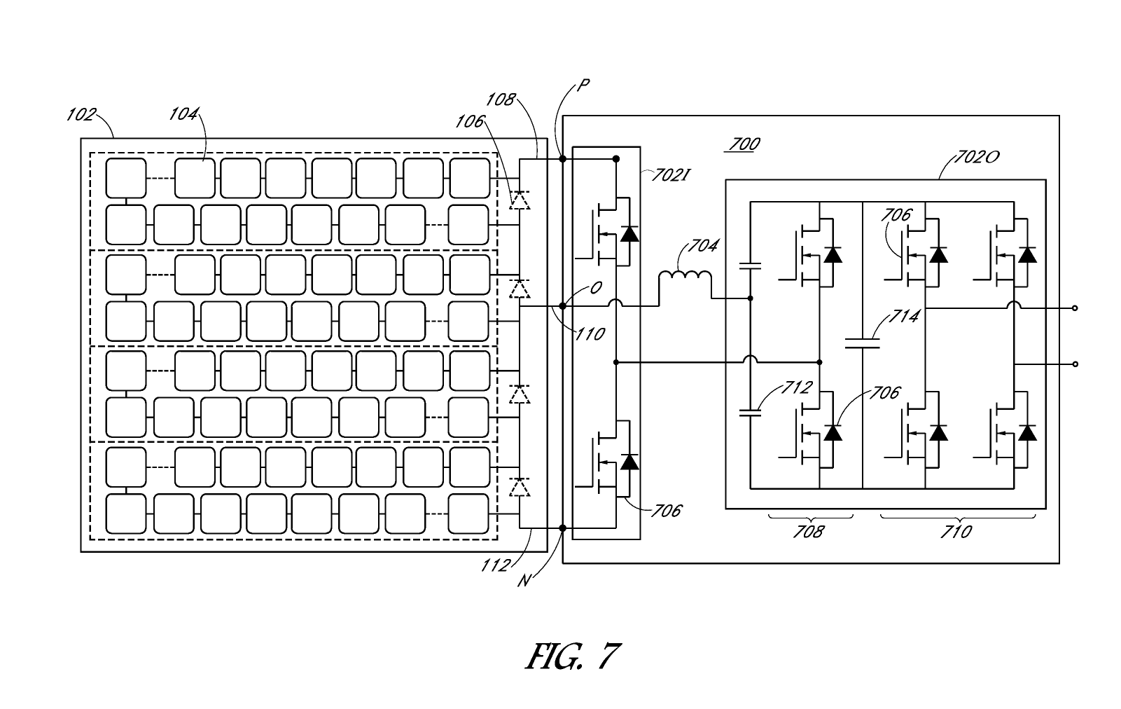

FIG. 7 is a simplified electrical schematic showing another topology 700 that may be used inside the MLPE 120 of FIGS. 1A and 1B. An energy generation portion 102 is shown in FIG. 7, although it will be understood that an energy generation portion 102S may be used instead. The energy generation portion 102 may be coupled to an MLPE 120 with topology 700 by the terminals 108, 110, and 112 at nodes P, O, and N, respectively. The topology 700 includes an input portion 702I and an output portion 702O, each including controlled switches 706. The controlled switches 706 are shown as power MOSFETs, but it will be understood that any electrically-controlled switch (e.g., power BJT, thyristor, etc.) may be used. The input portion 702I and output portion 702O are both coupled to an inductor 704. The input portion 702I and output portion 702O cooperate to form a DC-DC phase shift resonant converter. The input portion 702I is embodied as a DC-AC converter and, depending on the control algorithm used to control the controlled switches 706 of the input portion 702I, the input portion 702I may be operated to either boost or buck voltage. The output portion 702O is illustratively embodied as an AC-AC converter (e.g., a cycloconverter). Illustratively, the output portion 702O includes an DC-AC converter 708 coupled to a DC bus link capacitor 714 and a DC-AC inverter 710 also coupled to the DC bus link capacitor 708. The output portion 702O includes filtering capacitors 712 and a bus capacitor 714. Additionally, the DC bus capacitor 714 provides 120 Hz ripple filtering. The bypass diodes 106 may be omitted from the module 100 because an alternate bypass paths may be established through the controlled switches 706 in the input portion 702I. Further, no separate capacitors are shown because the inherent capacitance between the terminals 108 and 110 and between terminals 110 and 112 filters high frequency noise as discussed herein.

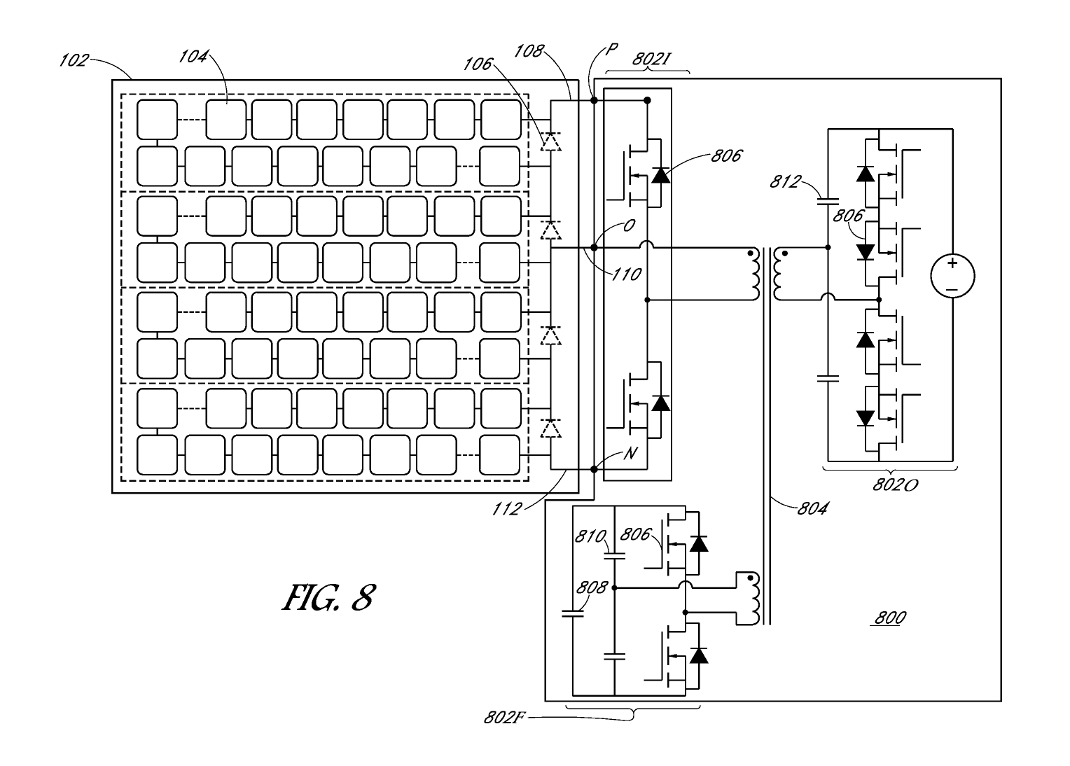

FIG. 8 is a simplified electrical schematic showing another topology 800 that may be used inside the MLPE 120 of FIGS. 1A and 1B. An energy generation portion 102 is shown in FIG. 8, although it will be understood that an energy generation portion 102S may be used instead. The energy generation portion 102 may be coupled to an MLPE 120 with topology 800 by the terminals 108, 110, and 112 at nodes P, O, and N, respectively. The topology 800 includes an input portion 802I, a filter portion 802F, and an output portion 802O, each including controlled switches 806. The controlled switches 806 are shown as power MOSFETs, but it will be understood that any electrically-controlled switch (e.g., power BJT, thyristor, etc.) may be used. The input portion 802I, output portion 802O, and filter potion 802F are all coupled to a transformer 804, which also galvanically isolates each portion from the others. The input portion 802I and output portion 802O cooperate to form a DC-DC phase shift resonant converter. The input portion 802I is embodied as a DC-AC converter and, depending on the control algorithm used to control the controlled switches 806 of the input portion 802I, the input portion 802I may be operated to either boost or buck voltage. The output portion 802O is illustratively embodied as a half-bridge AC-DC converter (although a full-bridge arrangement could also be used) with a pair of filtering capacitors 812. In other embodiments, the output portion 802O may be embodied as an AC-AC converter if the controlled switches 806 of the input portion 802I are embodied as bi-directional blocking switches and the control algorithm used to control the switches 606 of the output portion 802O is configured for AC-AC conversion. The filter portion 802F shown in FIG. 8 is an active filter including a pair of controlled switches 806 arranged in a half bridge, a bus capacitor 808 and filtering capacitors 810. The bypass diodes 106 may be omitted from the module 100 because an alternate bypass paths may be established through the controlled switches 806 in the input portion 802I. Further, no separate capacitors are shown because the inherent capacitance between the terminals 108 and 110 and between terminals 110 and 112 filters high frequency noise as discussed herein.

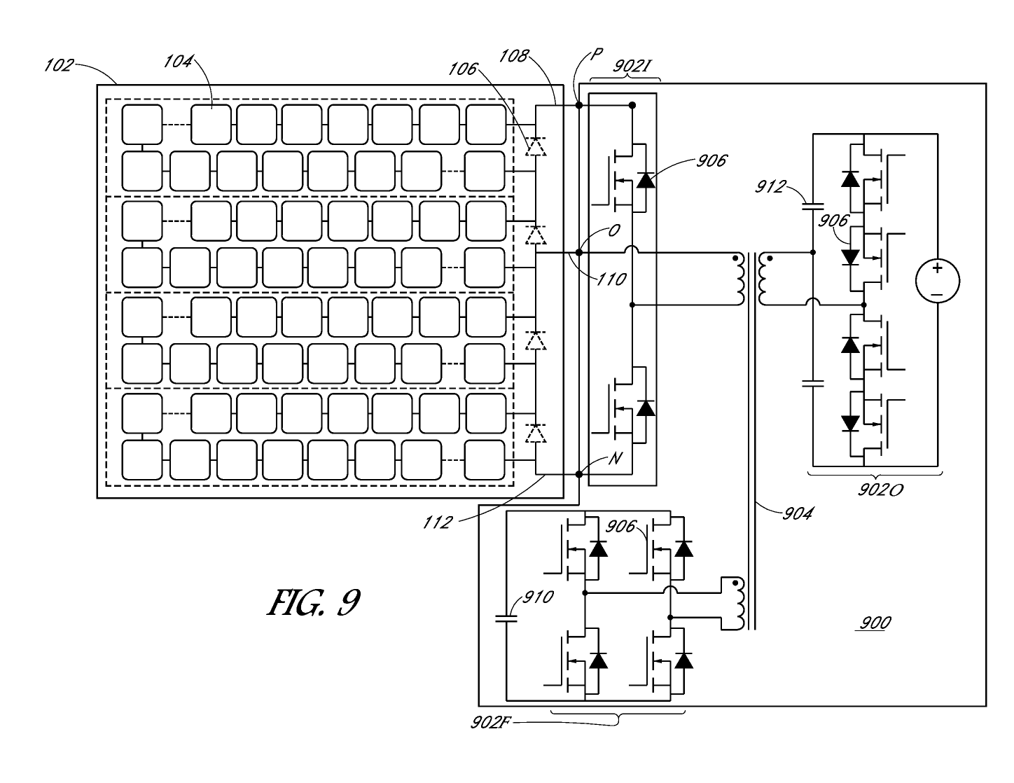

FIG. 9 is a simplified electrical schematic showing another topology 900 that may be used inside the MLPE 120 of FIGS. 1A and 1B. An energy generation portion 102 is shown in FIG. 9, although it will be understood that an energy generation portion 102S may be used instead. The energy generation portion 102 may be coupled to an MLPE 120 with topology 900 by the terminals 108, 110, and 112 at nodes P, O, and N, respectively. The topology 900 includes an input portion 902I, a filter portion 902F, and an output portion 902O, each including controlled switches 906. The controlled switches 906 are shown as power MOSFETs, but it will be understood that any electrically-controlled switch (e.g., power BJT, thyristor, etc.) may be used. The input portion 902I, output portion 902O, and filter potion 902F are all coupled to a transformer 904, which also galvanically isolates each portion from the others. The input portion 902I and output portion 902O cooperate to form a DC-DC phase shift resonant converter. The input portion 902I is embodied as a DC-AC converter and, depending on the control algorithm used to control the controlled switches 906 of the input portion 902I, the input portion 902I may be operated to either boost or buck voltage. The output portion 902O is illustratively embodied as a half-bridge AC-DC converter (although a full-bridge arrangement could also be used) with a pair of filtering capacitors 912. In other embodiments, the output portion 902O may be embodied as an AC-AC converter if the controlled switches 906 of the input portion 902I are embodied as bi-directional blocking switches and the control algorithm used to control the switches 606 of the output portion 802O is configured for AC-AC conversion. The filter portion 902F shown in FIG. 9 is an active filter including four controlled switches 906 arranged in a full bridge and a bus capacitor 910. The bypass diodes 106 may be omitted from the module 100 because an alternate bypass paths may be established through the controlled switches 906 in the input portion 902I. Further, no separate capacitors are shown because the inherent capacitance between the terminals 108 and 110 and between terminals 110 and 112 filters high frequency noise as discussed herein.

It will be understood that in each of the topologies discussed herein, it may be advantageous to replace half bridges with full bridges. For example, controlled switches 206, 406, 506, 606, 706, 806, 906 arranged in half bridges in their respective topologies 200, 400, 500, 600, 700, 800, 900 may be replaced with controlled switches arranged in full bridges with additional circuit reconfigurations. Alternatively, it may be advantageous to replace full bridges with half bridges (e.g., replacing the full bridge arrangement used in output converter 902O with a half bridge arrangement).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A solar module comprising:
a string of series-connected solar cells having a total voltage Vpanel;
a first terminal disposed at a positive end of the string;
a second terminal disposed at a midpoint of the string wherein half of the solar cells in the string occur before the midpoint in series;
a third terminal disposed at a negative end of the string; and
wherein the voltage between the first terminal and the second terminal is +Vpanel/2 volts, and wherein the voltage between the third terminal and the second terminal is −Vpanel/2 volts.

2. The solar module of claim 1 further comprising a module level power electronic (MLPE) device coupled to the first terminal, second terminal, and third terminal.

3. The solar module of claim 2 wherein the MLPE device is adapted to utilize the second terminal as a return path for a common mode signal.

4. The solar module of claim 2 wherein the MLPE device comprises an input conversion portion including:
a first controlled switch coupled to the first terminal; and
a second controlled switch coupled the third terminal;
wherein the first controlled switch and the second controlled switch are coupled to a primary winding of a transformer at a first end of the primary winding and wherein a second end of the primary winding is coupled to the second terminal.

5. The solar module of claim 4 wherein the MLPE device further comprises an output conversion portion comprising:
a second winding of the transformer, the second winding having a first end and a second end opposite the first end;
a third controlled switch coupled to the first end of the secondary winding;
a fourth controlled switch coupled the first end of the secondary winding;
a first capacitor having a first terminal and a second terminal, the first terminal of the first capacitor coupled to the third controlled switch; and
a second capacitor having a first terminal and a second terminal, the first terminal of the first capacitor coupled to the fourth controlled switch and the second end of the secondary winding;
wherein the second terminal of the first capacitor is coupled the second terminal of the second capacitor.

6. The solar module of claim 2 wherein the MLPE device comprises a DC-DC converter.

7. The solar module of claim 2 wherein the MLPE device comprises an inverter.

8. The solar module of claim 7 wherein the inverter is one of an inverter having a half-bridge topology, an inverter having a full-bridge topology, a neutral point clamped inverter, and a four legged inverter.

9. The solar module of claim 1 wherein the first terminal and second terminal are coupled to a bypass diode.

10. The solar module of claim 1, further comprising a fourth terminal disposed at a second midpoint of the string wherein one fourth of the solar cells in the string occur before the second midpoint of the string, wherein the voltage between the fourth terminal and the third terminal is +Vpanel/4 volts.

11. The solar module of claim 7 further comprising a module level power electronic (MLPE) device coupled to the first terminal, second terminal, third terminal, and fourth terminal.

12. The solar module of claim 1 wherein the string of solar cells is disposed within a laminate and wherein the first terminal, second terminal, and third terminals comprise leads coming out of the laminate.

13. A solar module comprising:
an energy generation portion comprising:
a string of series-connected solar cells having a total voltage Vpanel;
a first terminal disposed at a positive end of the string;
a second terminal disposed at a midpoint of the string wherein half of the solar cells in the string occur before the midpoint in series; and
a third terminal disposed at a negative end of the string;
wherein the voltage between the first terminal and the second terminal is +Vpanel/2 volts, and wherein the voltage between the third terminal and the second terminal is −Vpanel/2 volts; and
a module level power electronic (MLPE) device coupled to the energy generation portion, the MLPE device comprising:
a positive output terminal;
a negative output terminal coupled to the second terminal of the energy generation portion;
a capacitor having a positive terminal and a negative terminal;
a first electrical switch having a first terminal and a second terminal; and
a second electrical switch having a first terminal and a second terminal;
wherein the positive terminal of the capacitor, the first terminal of the energy generation portion, and the first terminal of the first electrical switch are coupled together,
wherein the negative terminal of the capacitor, the third terminal of the energy generation portion, and the second terminal of the second electrical switch are coupled together, and
wherein the second terminal of the first electrical switch, the first terminal of the second electrical switch, and the positive output terminal are coupled together.

14. The solar module of claim 13 wherein the negative output terminal of the MLPE device coupled to the second terminal of the energy generation portion comprise a return path for a common-mode signal.

15. The solar module of claim 13 where the first terminal of the energy generation portion and the second terminal of the energy generation portion are not coupled to a discrete capacitor.

16. The solar module of claim 13 where the third terminal of the energy generation portion and the second terminal of the energy generation portion are not coupled to a discrete capacitor.

17. The solar module of claim 13 wherein the first electrical switch and the second electrical switch comprise field effect transistors.

18. A solar module comprising:
a energy generation portion comprising:
a string of series-connected solar cells having a total voltage Vpanel;
a first terminal disposed at a positive end of the string;
a second terminal disposed at a midpoint of the string wherein half of the solar cells in the string occur before the midpoint in series; and
a third terminal disposed at a negative end of the string; and
wherein the voltage between the first terminal and the second terminal is +Vpanel/2 volts, and wherein the voltage between the third terminal and the second terminal is −Vpanel/2 volts; and
a neutral point clamped (NPC) inverter coupled to the energy generation portion, the neutral point clamped inverter comprising:
a positive input terminal coupled to the first terminal of the energy generation portion;
a neutral point terminal coupled to the second terminal of the energy generation portion and
a negative input terminal coupled to the third terminal of the energy generation portion.

19. The solar module of claim 18 wherein the NPC inverter is a three phase NPC inverter.

20. The solar module of claim 18 wherein the NPC inverter further comprises a plurality of diodes coupled to the neutral point terminal.
